(19) United States
(12) Patent Application Publication
(10) Pub. No.: US 2026/0371056 A1
(43) Pub. Date: Nov. 19, 2026

(54) SYSTEM AND METHOD FOR REAL-TIME MONITORING OF STRUCTURAL HEALTH OF REMOTE OCEAN ISLANDS

(71) Applicant: TIANJIN RESEARCH INSTITUTE FOR WATER TRANSPORT ENGINEERING.M.O.T., Tianjin (CN)

(72) Inventors: Jielong HU, Tianjin (CN); Songgui CHEN, Tianjin (CN); Zihao DUAN, Tianjin (CN); Yang WANG, Tianjin (CN); Qibo ZHANG, Tianjin (CN); Yina WANG, Tianjin (CN); Cheng PENG, Tianjin (CN); Yanan XU, Tianjin (CN); Zhen LIU, Tianjin (CN); Longzai GE, Tianjin (CN); Peng ZHAO, Tianjin (CN); Huili YANG, Tianjin (CN); Zuoda QI, Tianjin (CN); Jun MA, Tianjin (CN); Bin YU, Tianjin (CN)

(21) Appl. No.: 19/373,754

(22) Filed: Oct. 30, 2025

(30) Foreign Application Priority Data
May 19, 2025 (CN) 202510638048.3

(51) Int. Cl. H04W 4/90; G01C 13/00; G01V 1/01; G01W 1/10; G06F 30/27

(52) U.S. Cl. CPC H04W 4/90; G01C 13/002; G01V 1/01; G01W 1/10; G06F 30/27

(57) ABSTRACT

A system and a method for monitoring health of small islands in deep-sea and far-sea are provided. The system adopts a non-intrusive data collection system composed of a sensor networks, shore-based camera devices and vibration sensors; through the joint operation of a wave field distribution model and a structural damage prediction model, measured data are integrated with numerical simulations; through real-time correlation of the deviation analysis between historical disaster and current monitoring values, early warning thresholds are dynamically adjusted; finally, through an automatic triggering mechanism for multi-level early warning signals, a closed-loop system from data collection, model deduction to risk decision-making is established.

### CROSS-REFERENCE TO RELATED APPLICATIONS

This application claims priority to Chinese Patent Application No. 202510638048.3, filed on May 19, 2025, the contents of which are hereby incorporated by reference.

### TECHNICAL FIELD

The present disclosure relates to the technical field of real-time monitoring of structural health of remote ocean islands, and in particular to a system and a method for monitoring health of small islands in deep-sea and far-sea thereof.

### BACKGROUND

Small islands such as remote ocean islands in deep-sea and far-sea typically refer to islands or islets located more than 200 nautical miles from the continental coastline, isolated in open sea. These islands are predominantly composed of coral reefs, volcanic rocks, or sedimentary rocks, with relatively small surface areas and are difficult to instrument or service with conventional monitoring infrastructure.

Due to their unique geographical location, small islands in deep-sea and far-sea are persistently exposed to high-intensity winds and waves, extreme weather events (such as super typhoons and tsunamis), and complex ocean currents, resulting in significant dynamic changes in topography changes and coastal erosion. Meanwhile, the surrounding waters of deep-sea and far-sea islands are often hotspots of marine biodiversity, and their ecological health state directly affects coral reef ecosystems, fishery resources, and the stability of habitats for endangered species. The great depths and powerful waves in these areas create a highly complex marine environment, posing elevated risks of destruction to small islands and their structures during sudden disasters such as earthquakes, typhoon-induced waves, and storm surges and making continuous observation impractical.

However, the deep-sea and far-sea are characterized by great depths, powerful waves, and a highly complex marine environment. At the same time, there is a lack of long-term ocean observational data, and the coupling mechanism between hydraulic structures on islands and strong hydrodynamic loads remains unclear. Under sudden disasters such as earthquakes, typhoon-induced waves, and storm surges, small islands and their structures face high risks of destruction. Once protective engineering structures fail, the resulting strategic losses could lead to irreversible strategic losses.

Therefore, there is an urgent need for a system and a method for monitoring health of small islands in deep-sea and far-sea thereof to achieve rapid and accurate safety monitoring for these islands by integrating physical-environment data acquisition with high-performance numerical modeling and machine-learning-based adaptive control so that warning actions can be triggered automatically.

### SUMMARY

To address the above technical challenges, the disclosure provides a system for real-time monitoring of structural health of remote ocean islands, including a data collection module, a data simulation module, a machine learning module, and an early warning execution module;
the data collection module is used to collect offshore marine environmental data of an island in real time through a sensor network, obtain video image data of a reef flat area through a shore-based camera device, and obtain protective structure vibration data through a vibration sensor;
the data simulation module is connected to the data collection module, and includes a wave field distribution model and a structural damage prediction model; where the wave field distribution model is used to generate reef flat wave parameters based on the offshore marine environmental data, and the structural damage prediction model is used to output protective structure health information by combining reef flat wave parameters and protective structure vibration data;
the machine learning module is connected to the data simulation module, and used to dynamically generate early warning threshold ranges based on historical monitoring data and real-time monitoring data within a preset time window; where the early warning threshold ranges include a significant wave height threshold, a vibration main frequency deviation threshold, and a foundation settlement rate threshold; and
the early warning execution module is connected to the machine learning module, used to trigger multi-level early warning signals when the reef flat wave parameters or the protective structure health information exceed the early warning threshold ranges. The wave-field distribution model, the structural-damage prediction model, and the machine-learning threshold generator are implemented as executable code operating directly on sensor-generated signals within a graphics processing unit (GPU) accelerated cluster, thereby transforming raw vibration and hydrodynamic measurements into actionable early-warning commands for physical protective structures. The early-warning execution module is configured to initiate automated responses, such as activating shoreline sirens or sending actuation signals to wave-barrier control gates, whenever thresholds are exceeded.

In an embodiment, the data collection module includes:
a vibration sensor array, embedded inside the protective structures to form a self-organizing network;
a shore-based panoramic camera device, deployed at a highest point of the island and equipped with an anti-salt spray protective cover; and
a buoy array, distributed in an offshore area of the island and integrated with a Doppler velocimeter and a conductivity-temperature-depth (CTD) sensor.

In an embodiment, an operation of the wave field distribution model includes:
obtaining wind field data and inputting the wind field data into a wave numerical simulation model to obtain an offshore wave spectrum; and
taking the offshore wave spectrum as a boundary condition and inputting the offshore wave spectrum into a near-shore wave-current coupling model to calculate reef flat wave parameters; where the reef flat wave parameters include wave heights, periods, and flow velocity distributions in the reef flat area.

In an embodiment, a wave-foundation coupling dynamic response model is integrated between the wave field distribution model and the structural damage prediction model; where the wave-foundation coupling dynamic response model is used to:
obtain foundation stress distribution based on the reef flat wave parameters and foundation geological parameters; and
input the foundation stress distribution into the structural damage prediction model, and combine with the reef flat wave parameters and the protective structure vibration data to derive a protective structure health information.

In an embodiment, the data simulation module further includes a GPU parallel computing cluster to perform following operations:
performing joint compilation of the wave numerical model, the near-shore wave-current coupling model, and the wave-foundation coupling dynamic response model; and
when typhoon path prediction data is updated, preferentially allocating grid computing tasks within a preset radius area of a typhoon center to the GPU parallel computing cluster. This configuration reduces simulation latency by orders of magnitude relative to conventional CPU implementations, enabling time-critical structural-integrity predictions.

In an embodiment, steps for dynamically generating the early warning threshold ranges by the machine learning module include:
obtaining a historical monitoring dataset within the preset time window, where the dataset includes a significant wave height sequence, a vibration main frequency deviation sequence, and a foundation settlement rate sequence;
calculating historical means and standard deviations for each parameter and determining baseline thresholds based on the means plus N times the standard deviations, where N is a preset safety factor;
collecting monitoring values for a significant wave height, a vibration main frequency deviation, and a foundation settlement rate in real time; when any parameter deviates from the historical mean by more than a preset percentage, increasing or decreasing a corresponding threshold proportionally based on a deviation;
comparing dynamically adjusted thresholds with design specification thresholds, and selecting a smaller value as a final early warning threshold; and
activating a corresponding early warning signal when the real-time monitoring data exceeds the final early warning threshold.

In an embodiment, the data collection module further includes:
a bionic unmanned aerial vehicle (UAV) unit, adopting a flapping-wing silent structure and activated upon shoreline anomalies, with flight paths avoiding ecologically sensitive areas; and
a bionic coral camera unit, including a three dimensional (3D)-printed base and internal waterproof components, where surface texture of the base is consistent with surrounding coral morphology and integrates a wireless charging module.

In an embodiment, the system further includes a visualization module, used to fuse the real-time monitoring data, simulation results, and early warning information for 3D dynamically display.

In an embodiment, the visualization module includes:
a digital twin engine, fusing multi-temporal remote sensing data and monitoring results in real time to construct a 3D island model;
a disaster deduction interface, supporting interactive modification of typhoon paths and predicting of shoreline evolution trends in real time; and
a structural health monitoring dashboard, displaying vibration spectra and damage thermal maps of the protective structures.

On the other hand, the present disclosure also provides a method for monitoring health of small islands in deep-sea and far-sea., which is implemented based on any of the above systems for monitoring health of small islands in the deep-sea and far-sea, where the method includes:
collecting data: collecting offshore marine environmental data of the islands in real time through a sensor network, obtaining video image data of a reef flat area through a shore-based camera device, and obtaining protective structure vibration data through a vibration sensor;
simulating data: generating reef flat wave parameters through a wave field distribution model based on offshore marine environmental data, and outputting protective structure health information through a structural damage prediction model by combining the reef flat wave parameters and the protective structure vibration data;
dynamically generating early warning threshold ranges: dynamically generating early warning threshold ranges based on historical monitoring data and real-time monitoring data within a preset time window, wherein the early warning threshold includes a significant wave height threshold, a vibration main frequency deviation threshold, and a foundation settlement rate threshold; and
triggering a warning: triggering multi-level warning signals when the reef flat wave parameters or the protective structure health information exceed the warning threshold ranges.

The embodiments of the disclosure have the following technical effects.

The present disclosure provides a system for monitoring health of small islands in deep-sea and far-sea, which adopts a non-intrusive data collection system composed of a sensor networks, shore-based camera devices and vibration sensors. The system realizes full-element real-time monitoring of offshore environmental parameters, reef flat images and vibration status of protective structures, thereby avoiding the interference to the fragile island ecology caused by manual monitoring; secondly, through the joint operation of a wave field distribution model and a structural damage prediction model executes on a parallel GPU computing cluster that reduces hydrodynamic-simulation latency compared with conventional CPU implementations, enabling predictive calculations within the limited lead-time of approaching typhoons.; furthermore, by dynamically adjusting early warning thresholds based on machine learning algorithms and automatically trigger multi-level alerts that can actuate physical warning devices or protective systems, closing the loop from sensing to real-time mitigation. The system breaks through the limitation of traditional fixed thresholds that fail to adapt to changes in complex marine environments; through real-time correlation of the deviation analysis between historical disaster and current monitoring values, the intelligent optimization of early warning indicators is achieved, significantly enhancing the timeliness and accuracy of early warning for extreme events; finally, through an automatic triggering mechanism for multi-level early warning signals, a closed-loop system from data collection, model deduction to risk decision-making is established; the system provides all-weather and highly reliable safety monitoring guarantees for islands in deep-sea and far-sea, while reducing manual maintenance costs, and demonstrating significant technical synergy effects. In conclusion, by integrating multi-source data collection and model-based analysis and processing, the system effectively solves the shortcomings of low accuracy, ecological damage and high cost in traditional monitoring technologies.

### BRIEF DESCRIPTION OF THE DRAWINGS

In order to more clearly illustrate the specific implementations of the disclosure, the following will briefly introduce the drawings needed in the description of the specific implementations or the prior art. Obviously, the drawings in the following description are some implementations of the disclosure. For those of ordinary skill in the art, other drawings may be obtained according to these drawings without creative work.

FIG. 1 is the schematic diagram of modules of a system for monitoring health of small islands in deep-sea and far-sea according to an embodiment of the disclosure.

FIG. 2 is the relationship diagram of simulation models within the data simulation module according to an embodiment of the disclosure.

FIG. 3 is the flow chart of steps of a method for monitoring health of small islands deep-sea and far-sea according to an embodiment of the disclosure.

FIG. 4 is the flow chart of steps for dynamically generating the early warning threshold ranges by the machine learning module.

FIG. 5 is the schematic diagram of the data collecting process according to an embodiment of the disclosure.

### DETAILED DESCRIPTION OF THE EMBODIMENTS

To make the purposes, technical schemes and advantages of the disclosure clearer, the technical schemes of the disclosure will be clearly and completely described below. Obviously, the described embodiments are only a part of the embodiments of the disclosure, not all of them. Based on the embodiments in the disclosure, all other embodiments obtained by those of ordinary skill in the art without creative work belong to the protection scope of the disclosure.

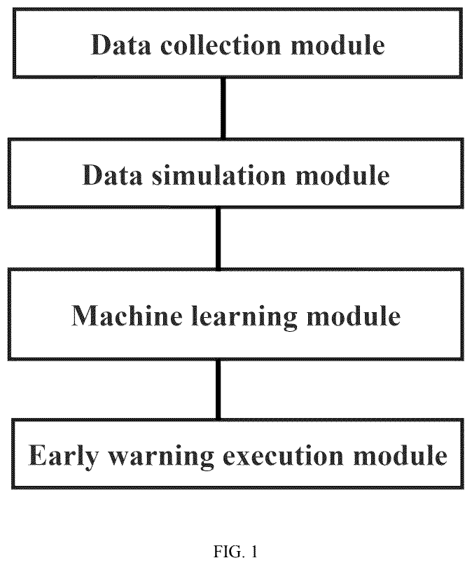

In order to realize rapid and accurate monitoring of the safety of small islands in deep-sea and far-sea, one aspect of the disclosure provides a system for monitoring health of small islands in deep-sea and far-sea, as shown in FIG. 1, including a data collection module, a data simulation module, a machine learning module, and an early warning execution module;
the data collection module is used to collect offshore marine environmental data of an island in real time through a sensor network, obtain video image data of a reef flat area through a shore-based camera device, and obtain protective structure vibration data through a vibration sensor;
the data collection module is responsible for integrating multi-type sensor networks, and collecting environmental parameters across different dimensions by utilizing vibration sensors, shore-based camera devices, and other devices.

In some embodiments, the data collection module includes:
a vibration sensor array, embedded inside the protective structures to form a self-organizing network;
a shore-based panoramic camera device, deployed at a highest point of the island and equipped with an anti-salt spray protective cover; and a buoy array, distributed in an offshore area of the island and integrated with a Doppler velocimeter and a conductivity-temperature-depth (CTD) sensor.

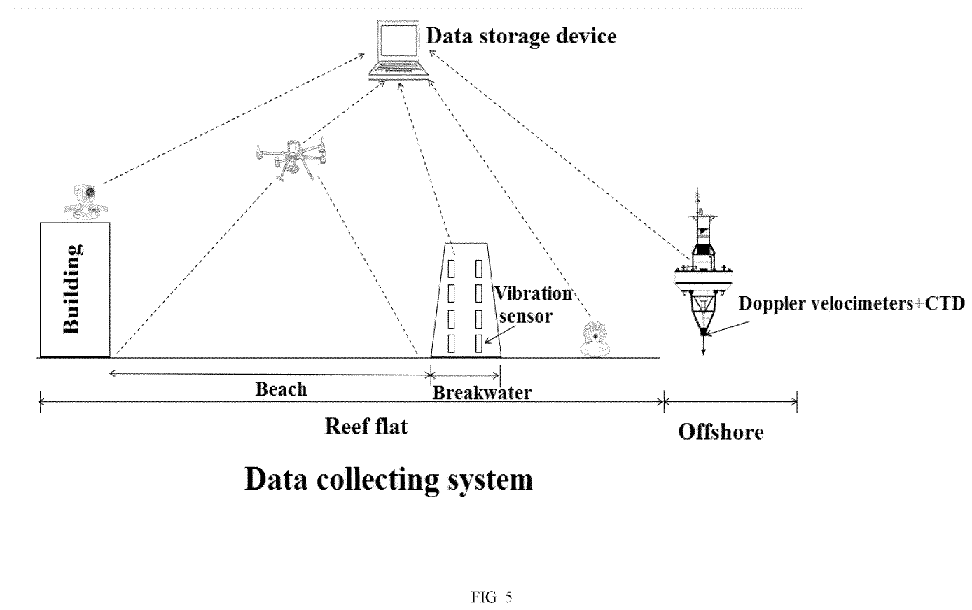

As shown in FIG. 5, vibration sensors are embedded inside the protective structures concrete or steel support members of the seawall and other wave-barrier structures, positioned near joints and high-stress points to capture foundation and structural response, and transmit the structural vibration status in real-time via self-organizing networks. As an exemplary implementation, a distributed deployment strategy is adopted, and miniature accelerometers are installed at key load-bearing nodes of the protective structures, and multi-node data synchronous collection and redundant transmission are realized through wireless ad-hoc network technology. The shore-based camera devices are mounted at the highest points of the islands, equipped with anti-salt-spray protective housings to withstand harsh marine climates, ensuring long-term stable operation in highly corrosive environments, and allowing continuous capture of video imagery over reef flat areas. As an exemplary implementation, a high-resolution optical lens is exemplarily selected. Buoy arrays are distributed in the open ocean, integrating Doppler velocimeters and CTD sensors to periodically transmit marine environmental data. As an exemplary implementation, buoys are arranged in a radial pattern around the island, each equipped with a Doppler velocimeter, a CTD sensor, and a BeiDou positioning module, and real-time marine parameters are transmitted back via satellite links. The buoys form a collaborative observation network through underwater acoustic communication. If a buoy shifts or malfunctions, adjacent buoys automatically adjust their observation frequency to maintain data continuity. The design achieves all-round and multi-dimensional monitoring of marine environmental parameters through spatially optimized deployment of multi-source heterogeneous sensors.

In some embodiments, the data collection module further includes:
a bionic unmanned aerial vehicle (UAV) unit, adopting a flapping-wing silent structure and activated upon shoreline anomalies, with flight paths avoiding ecologically sensitive areas; and a body of the UAV is equipped with a multispectral imager and a laser radar, and identifies shoreline erosion characteristics in real-time through edge computing.
a bionic coral camera unit, including a three dimensional (3D)-printed base and internal waterproof components, where surface texture of the base is consistent with surrounding coral morphology and integrates a wireless charging module. The 3D printed base is made of biocompatible materials. When surrounding organisms approach, the camera unit automatically enters a dormant mode to reduce ecological interference. Such bionic monitoring equipment maximizes the maintenance of the original ecosystem balance while ensuring the quality of data collection.

The data simulation module is connected to the data collection module, and includes a wave field distribution model and a structural damage prediction model; where the wave field distribution model is used to generate reef flat wave parameters based on the offshore marine environmental data, and the structural damage prediction model is used to output protective structure health information by combining reef flat wave parameters and protective structure vibration data;

In some embodiments, an operation of the wave field distribution model includes:
obtaining wind field data and inputting the wind field data into a wave numerical simulation model to obtain an offshore wave spectrum; and
taking the offshore wave spectrum as a boundary condition and inputting the offshore wave spectrum into a near-shore wave-current coupling model to calculate reef flat wave parameters; where the reef flat wave parameters includes wave heights, periods, and flow velocity distributions in the reef flat area.

The present disclosure directly adopts the existing wave numerical simulation model without improvement. The input parameter wind field data includes wind speed, wind direction, fetch length, wind duration, atmospheric pressure, etc., and the output is reef flat wave parameters.

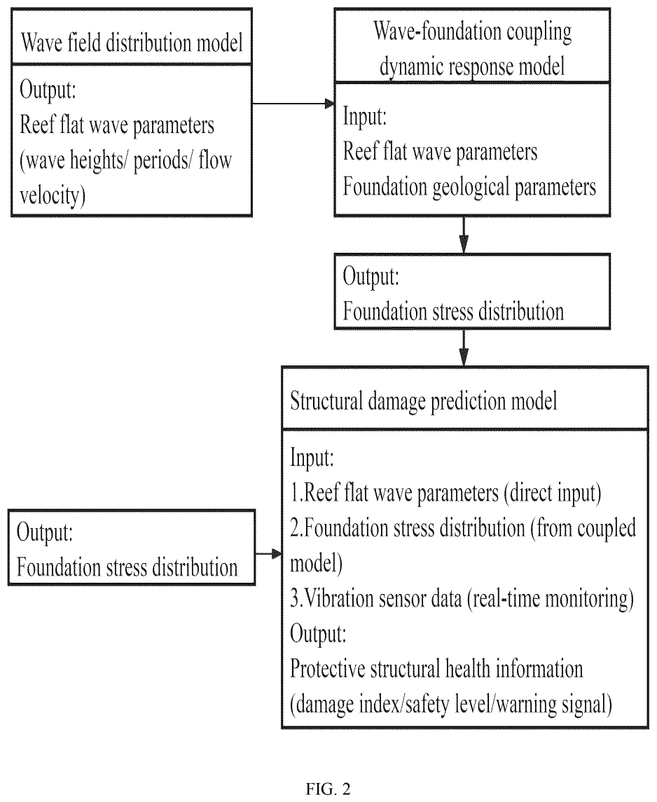

In some embodiments, a wave-foundation coupling dynamic response model is integrated between the wave field distribution model and the structural damage prediction model; as shown in FIG. 2, the wave-foundation coupling dynamic response model is used to:
obtain foundation stress distribution based on the reef flat wave parameters and foundation geological parameters; as an exemplary implementation, the wave-foundation coupled dynamic response model may be realized by finite element simulation; and
input the foundation stress distribution into the structural damage prediction model, and combine with the reef flat wave parameters and the protective structure vibration data to derive a protective structure health information.

The vibration data of the protective structures is a direct measurement of structural response, which may be used to verify the prediction results of the model and make real-time adjustments. For example, changes in the vibration spectrum may indicate loss of structural stiffness or loosening of connecting nodes. However, the foundation stress distribution reflects the impact of wave loads on the foundation, which is an important factor for structural damage. Using vibration data alone may only detect the immediate response of the structure, but combining with foundation stress may predict long-term cumulative damage. For example, stress concentration in the foundation may lead to uneven settlement of the structure foundation, thereby causing structural damage. Incorporating foundation stress distribution into structural damage prediction models may improve the accuracy of damage detection, enhance early warning capabilities, reduce false alarms and missed alarms, extend the service life of the structure, and lower maintenance costs. For example, through the analysis of foundation stress, fatigue damage may be predicted before visible cracks appear in the structure, thereby maintenance may be carried out in advance.

The data simulation module significantly reduces the dependence on traditional intensive field monitoring, through the joint operation of the wave field distribution model and the structural damage prediction model. The wave field model uses limited wind field data collected from offshore buoys to simulate and invert the distribution of wave parameters in the entire reef flat area, replacing the traditional direct measurement method of arranging wave gauges at key points of the reef flat. This reduces the number of underwater sensors deployed and lowers maintenance costs. The structural damage model combines reef flat wave parameters and vibration data of protective structures, avoiding the need to densely install accelerometers across the entire surface of the structure. While ensuring evaluation accuracy, the data simulation module greatly reduces the difficulty of equipment deployment and data collection costs in the harsh environment of deep-sea and far-sea, extends the intervention-free operation cycle of the monitoring system, and minimizes the environmental damage caused by human activities.

In some embodiments, the data simulation module further includes a graphics processing unit (GPU) parallel computing cluster to perform following operations: performing joint compilation of the wave numerical model, near-shore wave-current coupling model, and wave-foundation coupling dynamic response model; and
when typhoon path prediction data is updated, prioritizing allocating grid computing tasks within a preset radius area of a typhoon center to the GPU parallel computing cluster. When the typhoon path changes, the GPU cluster rapidly recalculates wave parameters to ensure the timeliness of early warning. In addition, joint compilation of multiple models enables these models to work efficiently and cooperatively on the same cluster, reducing data transmission delay and improving overall computing efficiency.

The GPU parallel computing cluster is a hardware architecture that uses multiple GPUs for parallel processing to accelerate computing tasks. The GPU parallel computing cluster performs joint compilation optimization for the wave numerical model, near-shore wave-current coupling model and wave-foundation coupled dynamic response model to realize dynamic load balancing of computing tasks. When the typhoon track prediction data is updated, the system automatically identifies the computing grid within the influence range of the typhoon center, and preferentially allocates high-priority tasks to the GPU cluster for accelerated computing. The parallel computing framework adopts an unstructured grid partitioning strategy combined with a dynamic memory allocation algorithm, significantly improving the computing efficiency of large-scale wave field simulation. The design ensures real-time computing needs under extreme weather such as typhoons through intelligent task scheduling and hardware acceleration.

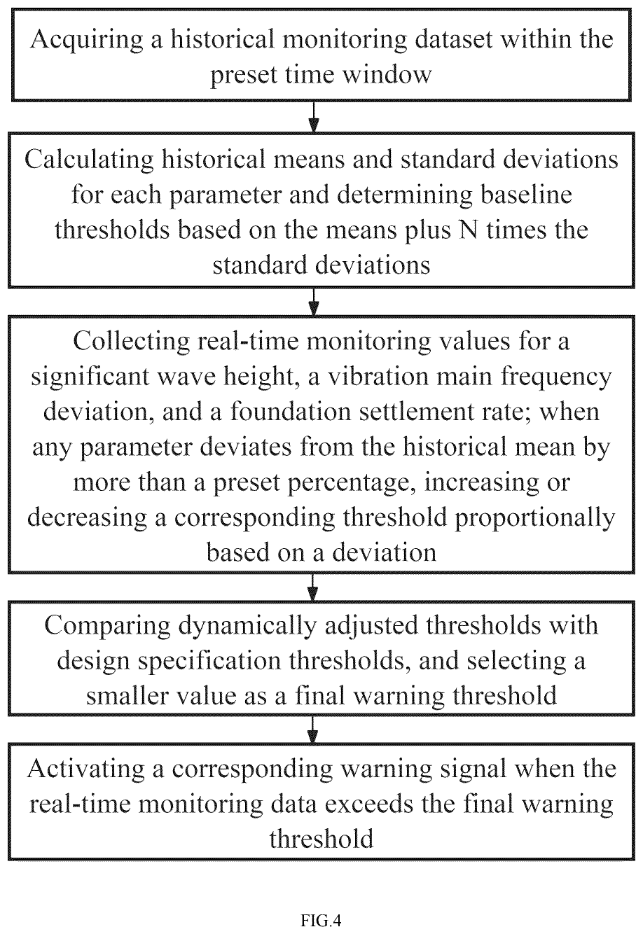

The machine learning module is connected to the data simulation module, and used to dynamically generate early warning threshold ranges based on historical monitoring data and real-time monitoring data within a preset time window; where the early warning threshold ranges include a significant wave height threshold, a vibration main frequency deviation threshold, and a foundation settlement rate threshold;
in some embodiments, as shown in FIG. 4, steps for dynamically generating the early warning threshold ranges of the machine learning module include:
obtaining a historical monitoring dataset within the preset time window, where the dataset includes a significant wave height sequence, a vibration main frequency deviation sequence, and a foundation settlement rate sequence;
calculating historical means and standard deviations for each parameter and determining baseline thresholds based on the means plus N times the standard deviations, where N is a preset safety factor;
collecting monitoring values for a significant wave height, a vibration main frequency deviation, and a foundation settlement rate in real time; when any parameter deviates from the historical mean by more than a preset percentage, increasing or decreasing a corresponding threshold proportionally based on a deviation;
comparing dynamically adjusted thresholds with design specification thresholds, and selecting a smaller value as a final early warning threshold; and
activating a corresponding early warning signal when the real-time monitoring data exceeds the final early warning threshold.

The dynamic early warning threshold generation mechanism adopts a sliding time window technology to continuously update the historical monitoring database. Time series analysis is performed on parameters such as significant wave height, vibration main frequency deviation, and foundation settlement rate. When a trend-based deviation is detected in the real-time monitoring values, the system automatically adjusts the threshold sensitivity. The mechanism effectively improves the environmental adaptability of the early warning system, enhances the accuracy of early warning, so as to adapt to the complex and volatile marine environment of small islands in deep-sea and far-sea. The mechanism also reduces maintenance costs, and extends the autonomous operation time of the system. For example, during the typhoon season, the significant wave height may be higher than normal, and the static threshold may not be applicable. Therefore, it is necessary to dynamically adjust the early warning threshold, and the early warning sensitivity may be optimized in response to the current situation.

The early warning execution module is connected to the machine learning module, used to trigger multi-level early warning signals when the reef flat wave parameters or the protective structure health information exceed the early warning threshold ranges.

In some embodiments, the system further includes a visualization module, used to fuse the real-time monitoring data, simulation results, and early warning information for 3D dynamically display.

In some embodiments, the visualization module includes:
a digital twin engine, fusing multi-temporal remote sensing data and monitoring results to construct a 3D island model in real time;
a disaster deduction interface, supporting interactive modification of typhoon paths and prediction of shoreline evolution trends in real time; and
a structural health monitoring dashboard, displaying vibration spectra and damage thermal maps of the protective structures.

As an exemplary implementation, the visualization module may also adopt a 3D geographic information system engine, fusing multi-temporal remote sensing images and real-time monitoring data to construct a digital twin. The disaster deduction function supports interactive modification of typhoon tracks and prediction of shoreline evolution trends under different scenarios in real time. The data dashboard provides multi-dimensional statistical analysis charts, supporting the replay of the development process of historical disaster events according to the time axis. The virtual reality interface may generate an immersive observation environment to assist managers in intuitively evaluating the state of protective engineering structures.

The present disclosure provides a system for monitoring health of small islands in deep-sea and far-sea, which adopts a non-intrusive data collection system composed of a sensor networks, shore-based camera devices and vibration sensors. The system realizes full-element monitoring of offshore environmental parameters, reef flat images and vibration status of protective structures in real time, thereby avoiding the interference to the fragile island ecology caused by manual monitoring; secondly, through the joint operation of a wave field distribution model and a structural damage prediction model, measured data are integrated with numerical simulations, significantly improving the spatial-temporal resolution of reef flat wave parameters and the evaluation accuracy of the health status of protective structures; furthermore, by dynamically adjusting early warning thresholds based on machine learning algorithms, the system breaks through the limitation of traditional fixed thresholds that fail to adapt to changes in complex marine environments; through correlation of the deviation analysis between historical disaster and current monitoring values in real time, the intelligent optimization of early warning indicators is achieved, significantly enhancing the timeliness and accuracy of early warning for extreme events; finally, through an automatic triggering mechanism for multi-level early warning signals, a closed-loop system from data collection, model deduction to risk decision-making is established; the system provides all-weather and highly reliable safety monitoring guarantees for islands in deep-sea and far-sea, while reduces manual maintenance costs, and demonstrates significant technical synergy effects. In conclusion, by integrating multi-source data collection and model-based analysis and processing, the system effectively solves the shortcomings of low accuracy, ecological damage and high cost in traditional monitoring technologies.

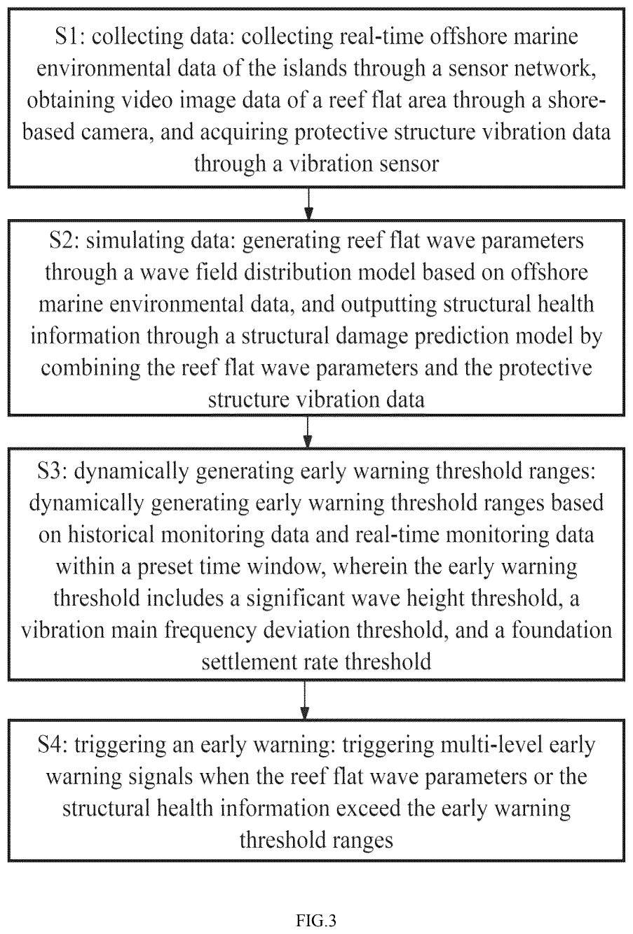

On the other hand, the present disclosure also provides a method for monitoring health of small island in a deep-sea and far-sea, which is implemented based on any of the above systems for monitoring health of small islands in deep-sea and far-sea, as shown in FIG. 3, the method includes:
S1: collecting data: collecting offshore marine environmental data of the islands in real time through a sensor network, obtaining video image data of a reef flat area through a shore-based camera device, and obtaining protective structure vibration data through a vibration sensor;
S2: simulating data: generating reef flat wave parameters through a wave field distribution model based on offshore marine environmental data, and outputting protective structure health information through a structural damage prediction model by combining the reef flat wave parameters and the protective structure vibration data;
S3: dynamically generating early warning threshold ranges: dynamically generating early warning threshold ranges based on historical monitoring data and real-time monitoring data within a preset time window, where the early warning threshold includes a significant wave height threshold, a vibration main frequency deviation threshold, and a foundation settlement rate threshold; and
S4: triggering an early warning: triggering multi-level early warning signals when the reef flat wave parameters or the protective structure health information exceed the early warning threshold ranges.

Finally, it is required to be noted that the above embodiments are only used to illustrate the technical schemes of the disclosure, not to limit them; although the disclosure has been described in detail with reference to the foregoing embodiments, those of ordinary skill in the art should understand that: it may still modify the technical schemes described in the foregoing embodiments, or replace some or all of the technical features therein; and these modifications or replacements do not make the essence of the corresponding technical schemes deviate from the technical schemes of the embodiments of the disclosure.

What is claimed is:

1. A system for monitoring health of small islands in deep-sea and far-sea, comprising a data collection module, a data simulation module, a machine learning module, and an early warning execution module; wherein
the data collection module is used to collect offshore marine environmental data of an island in real time through a sensor network, obtain video image data of a reef flat area through a shore-based camera device, and obtain protective structure vibration data through a vibration sensor;
the data simulation module is connected to the data collection module, and comprises a wave field distribution model and a structural damage prediction model; wherein the wave field distribution model is used to generate reef flat wave parameters based on the offshore marine environmental data, and the structural damage prediction model is used to output protective structure health information by combining reef flat wave parameters and protective structure vibration data;
the machine learning module is connected to the data simulation module, used to dynamically generate early warning threshold ranges based on historical monitoring data and real-time monitoring data within a preset time window; wherein the early warning threshold ranges comprise a significant wave height threshold, a vibration main frequency deviation threshold, and a foundation settlement rate threshold; and
the early warning execution module is connected to the machine learning module, used to trigger multi-level early warning signals when the reef flat wave parameters or the protective structure health information exceed the early warning threshold ranges;
wherein steps for dynamically generating the early warning threshold ranges by the machine learning module comprise:
obtaining a historical monitoring dataset within the preset time window, wherein the dataset comprises a significant wave height sequence, a vibration main frequency deviation sequence, and a foundation settlement rate sequence;
calculating historical means and standard deviations for each parameter and determining baseline thresholds based on the means plus N times the standard deviations, wherein N is a preset safety factor;
collecting monitoring values for a significant wave height, a vibration main frequency deviation, and a foundation settlement rate in real time; when any parameter deviates from the historical mean by more than a preset percentage, increasing or decreasing a corresponding threshold proportionally based on a deviation;
comparing dynamically adjusted thresholds with design specification thresholds, and selecting a smaller value as a final early warning threshold; and
activating a corresponding early warning signal when the real-time monitoring data exceeds the final early warning threshold.

2. The system for monitoring the health of the small islands in deep-sea and far-sea according to claim 1, wherein the data collection module comprises:
a vibration sensor array, embedded inside the protective structures to form a self-organizing network;
a shore-based panoramic camera device, deployed at a highest point of the island and equipped with an anti-salt spray protective cover; and
a buoy array, distributed in an offshore area of the island and integrated with a Doppler velocimeter and a conductivity-temperature-depth (CTD) sensor.

3. The system for monitoring the health of the small islands in deep-sea and far-sea according to claim 1, wherein an operation of the wave field distribution model comprises:
obtaining wind field data and inputting the wind field data into a wave numerical simulation model to obtain an offshore wave spectrum; and
taking the offshore wave spectrum as a boundary condition and inputting the offshore wave spectrum into a near-shore wave-current coupling model to calculate reef flat wave parameters; wherein the reef flat wave parameters comprises wave heights, periods, and flow velocity distributions in the reef flat area.

4. The system for monitoring the health of the small islands in deep-sea and far-sea according to claim 3, wherein a wave-foundation coupling dynamic response model is integrated between the wave field distribution model and the structural damage prediction model; wherein the wave-foundation coupling dynamic response model is used to:
obtain foundation stress distribution based on the reef flat wave parameters and foundation geological parameters; and
input the foundation stress distribution into the structural damage prediction model, and combine with the reef flat wave parameters and the protective structure vibration data to obtain a protective structure health information.

5. The system for monitoring the health of the small islands in deep-sea and far-sea according to claim 3, wherein the data simulation module further comprises a graphics processing unit (GPU) parallel computing cluster to perform following operations:
performing joint compilation of the wave numerical model, the near-shore wave-current coupling model, and the wave-foundation coupling dynamic response model; and
when typhoon path prediction data is updated, preferentially allocating grid computing tasks within a preset radius area of a typhoon center to the GPU parallel computing cluster.

6. The system for monitoring the health of the small islands in deep-sea and far-sea according to claim 1, wherein the data collection module further comprises:
a bionic unmanned aerial vehicle (UAV) unit, adopting a flapping-wing silent structure and activated upon shoreline anomalies, with flight paths avoiding ecologically sensitive areas; and
a bionic coral camera unit, comprising a three dimensional (3D)-printed base and internal waterproof components, wherein surface texture of the base is consistent with surrounding coral morphology and integrates a wireless charging module.

7. The system for monitoring the health of the small islands in deep-sea and far-sea according to claim 1, wherein the system further comprises a visualization module, used to fuse the real-time monitoring data, simulation results, and early warning information for 3D dynamically display.

8. The system for monitoring the health of the small islands in deep-sea and far-sea according to claim 7, wherein the visualization module comprises:
a digital twin engine, fusing multi-temporal remote sensing data and monitoring results in real time to construct a 3D island model;
a disaster deduction interface, supporting interactive modification of typhoon paths and predicting of shoreline evolution trends in real time; and
a structural health monitoring dashboard, displaying vibration spectra and damage thermal maps of the protective structures.

9. A method for monitoring health of small islands in deep-sea and far-sea, implemented based on the system for monitoring the health of the small islands in deep-sea and far-sea according to claim 1, wherein the method comprises:
collecting data: collecting offshore marine environmental data of the islands in real time through a sensor network, obtaining video image data of a reef flat area through a shore-based camera, and obtaining protective structure vibration data through a vibration sensor;
simulating data: generating reef flat wave parameters through a wave field distribution model based on offshore marine environmental data, and outputting protective structure health information through a structural damage prediction model by combining the reef flat wave parameters and the protective structure vibration data;
dynamically generating early warning threshold ranges: dynamically generating early warning threshold ranges based on historical monitoring data and real-time monitoring data within a preset time window, wherein the early warning threshold comprises a significant wave height threshold, a vibration main frequency deviation threshold, and a foundation settlement rate threshold; and
triggering an early warning: triggering multi-level early warning signals when the reef flat wave parameters or the protective structure health information exceed the early warning threshold ranges.
